(19) United States
(12) Patent Application Publication
(10) Pub. No.: US 2023/0345502 A1
(43) Pub. Date: Oct. 26, 2023

(54) CARRIER INDICATOR FIELD MAPPING

(71) Applicant: QUALCOMM Incorporated, San Diego, CA (US)

(72) Inventors: Kazuki TAKEDA, Minato-ku (JP); Peter GAAL, San Diego, CA (US); Wanshi CHEN, San Diego, CA (US); Juan MONTOJO, San Diego, CA (US); Alberto RICO ALVARINO, San Diego, CA (US); Mostafa KHOSHNEVISAN, San Diego, CA (US)

(21) Appl. No.: 18/148,241

(22) Filed: Dec. 29, 2022

Related U.S. Application Data
(60) Provisional application No. 63/363,367, filed on Apr. 21, 2022.

(51) Int. Cl. H04W 72/231; H04W 72/12

(52) U.S. Cl. CPC H04W 72/231; H04W 72/12

(57) ABSTRACT

Various aspects of the present disclosure generally relate to wireless communication. In some aspects, a user equipment (UE) may receive downlink control information including a carrier indicator field (CIF) value identifying one or more cells on which the downlink control information is configured to schedule resources. The UE may communicate on the one or more cells based at least in part on a mapping between the CIF value and the one or more cells. Numerous other aspects are described.

### CROSS-REFERENCE TO RELATED APPLICATION

This Patent Application claims priority to U.S. Provisional Pat. Application No. 63/363,367, filed on Apr. 21, 2022, entitled “CARRIER INDICATOR FIELD MAPPING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for carrier indicator field mapping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of downlink control information (DCI) that schedules multiple cells, in accordance with the present disclosure.

FIGS. 5A-5K are diagrams illustrating examples associated with carrier indicator field (CIF) mapping, in accordance with the present disclosure.

FIGS. 6-7 are diagrams illustrating example processes associated with CIF mapping, in accordance with the present disclosure.

FIGS. 8-9 are diagrams of example apparatuses for wireless communication, in accordance with the present disclosure.

### SUMMARY

Some aspects described herein relate to a method of wireless communication performed by a user equipment (UE). The method may include receiving downlink control information including a carrier indicator field (CIF) value identifying one or more cells on which the downlink control information is configured to schedule resources. The method may include communicating on the one or more cells based at least in part on a mapping between the CIF value and the one or more cells.

Some aspects described herein relate to a method of wireless communication performed by a network node. The method may include transmitting, to a UE, downlink control information including a CIF value identifying one or more cells on which the downlink control information is configured to schedule resources. The method may include communicating with the UE on the one or more cells based at least in part on a mapping between the CIF value and the one or more cells.

Some aspects described herein relate to a non-transitory computer-readable medium that stores a set of instructions for wireless communication by a UE. The set of instructions, when executed by one or more processors of the UE, may cause the UE to receive downlink control information including a CIF value identifying one or more cells on which the downlink control information is configured to schedule resources. The set of instructions, when executed by one or more processors of the UE, may cause the UE to communicate on the one or more cells based at least in part on a mapping between the CIF value and the one or more cells.

Some aspects described herein relate to a non-transitory computer-readable medium that stores a set of instructions for wireless communication by a network node. The set of instructions, when executed by one or more processors of the network node, may cause the network node to transmit, to a UE, downlink control information including a CIF value identifying one or more cells on which the downlink control information is configured to schedule resources. The set of instructions, when executed by one or more processors of the network node, may cause the network node to communicate with the UE on the one or more cells based at least in part on a mapping between the CIF value and the one or more cells.

Some aspects described herein relate to an apparatus for wireless communication. The apparatus may include means for receiving downlink control information including a CIF value identifying one or more cells on which the downlink control information is configured to schedule resources. The apparatus may include means for communicating on the one or more cells based at least in part on a mapping between the CIF value and the one or more cells.

Some aspects described herein relate to an apparatus for wireless communication. The apparatus may include means for transmitting, to a UE, downlink control information including a CIF value identifying one or more cells on which the downlink control information is configured to schedule resources. The apparatus may include means for communicating with the UE on the one or more cells based at least in part on a mapping between the CIF value and the one or more cells.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

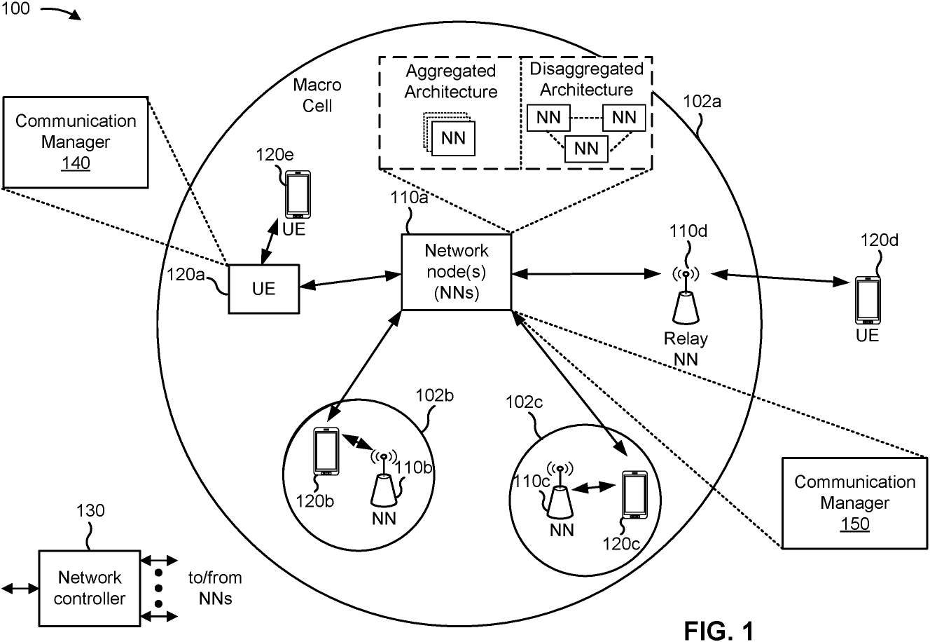

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive downlink control information including a carrier indicator field (CIF) value identifying one or more cells on which the downlink control information is configured to schedule resources; and communicate on the one or more cells based at least in part on a mapping between the CIF value and the one or more cells. Additionally, or alternatively, the communication manager 140 may perform one or more other operations described herein.

In some aspects, the network node 110 may include a communication manager 150. As described in more detail elsewhere herein, the communication manager 150 may transmit, to a UE, downlink control information including a CIF value identifying one or more cells on which the downlink control information is configured to schedule resources; and communicate with the UE on the one or more cells based at least in part on a mapping between the CIF value and the one or more cells. Additionally, or alternatively, the communication manager 150 may perform one or more other operations described herein.

As indicated above, FIG. 1 is provided as an example. Other examples may differ from what is described with regard to FIG. 1.

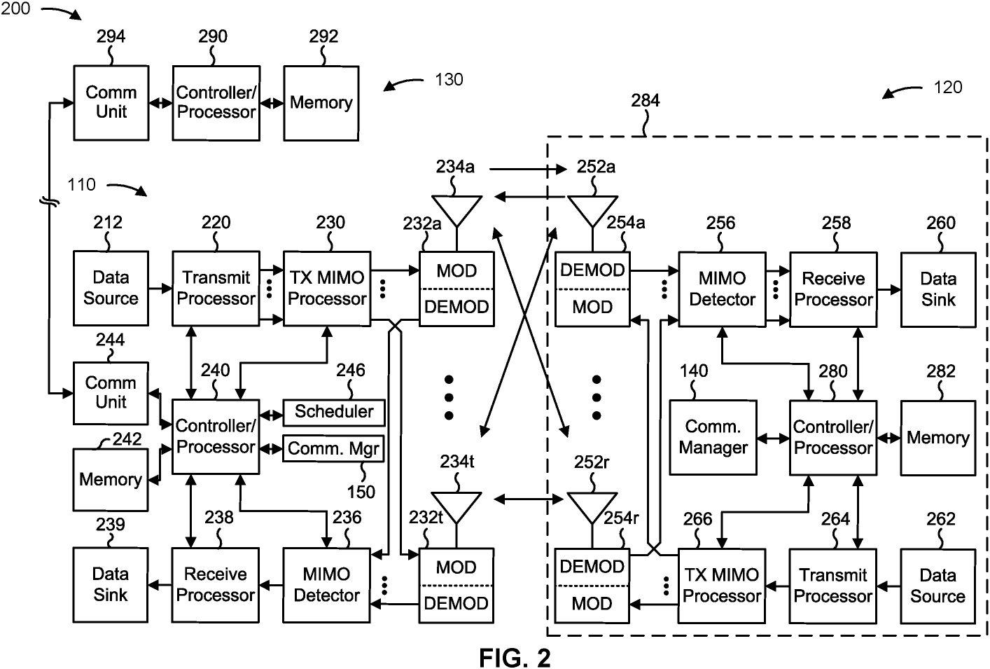

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T ≥ 1). The UE 120 may be equipped with a set of antennas 252a through 252r, such as R antennas (R ≥ 1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

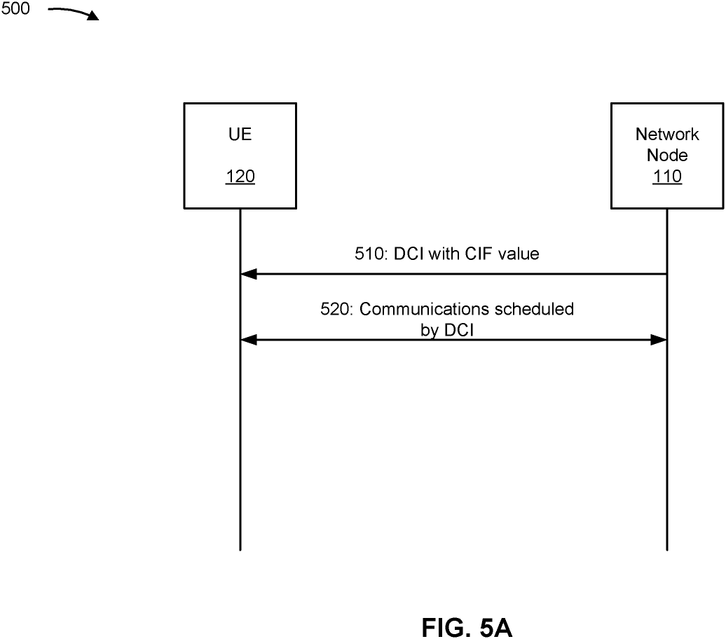

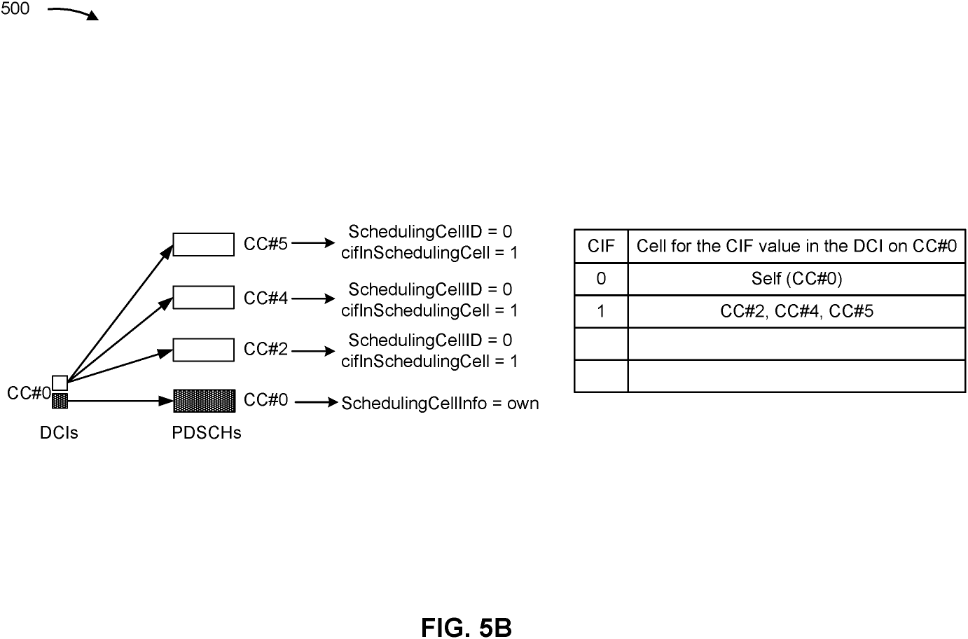

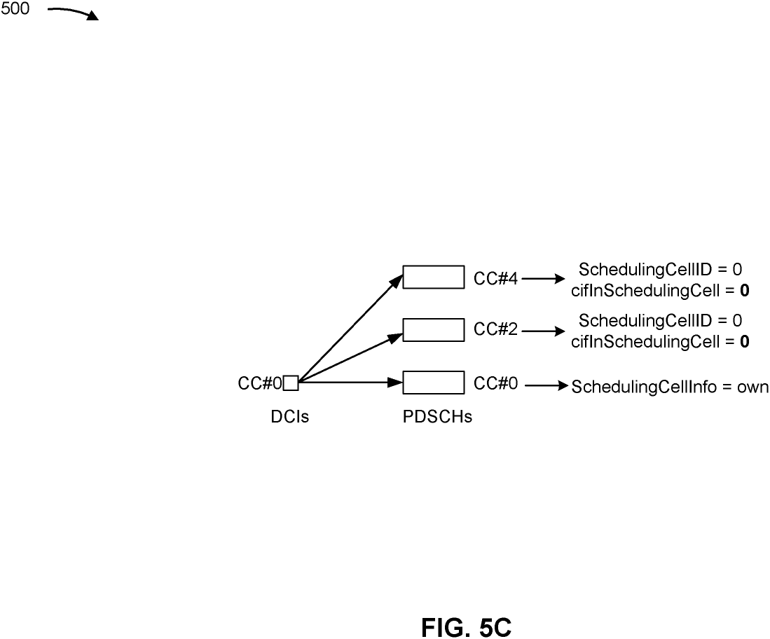

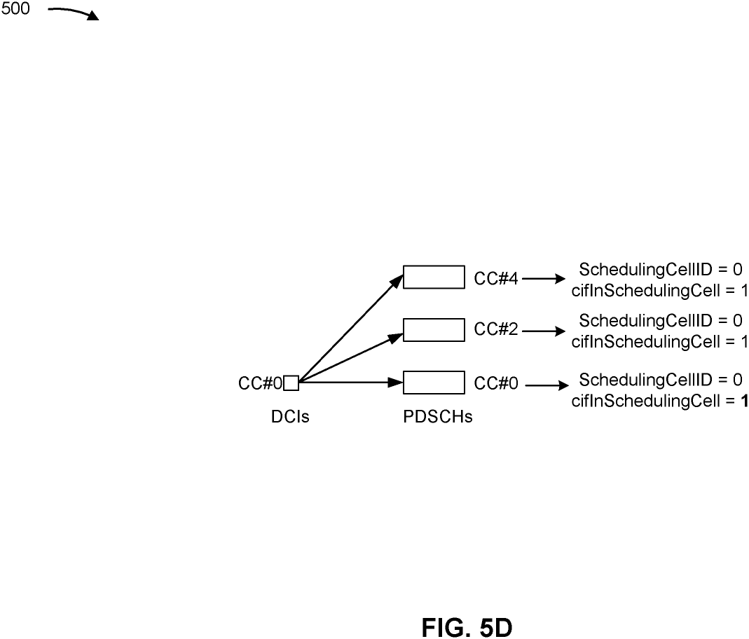

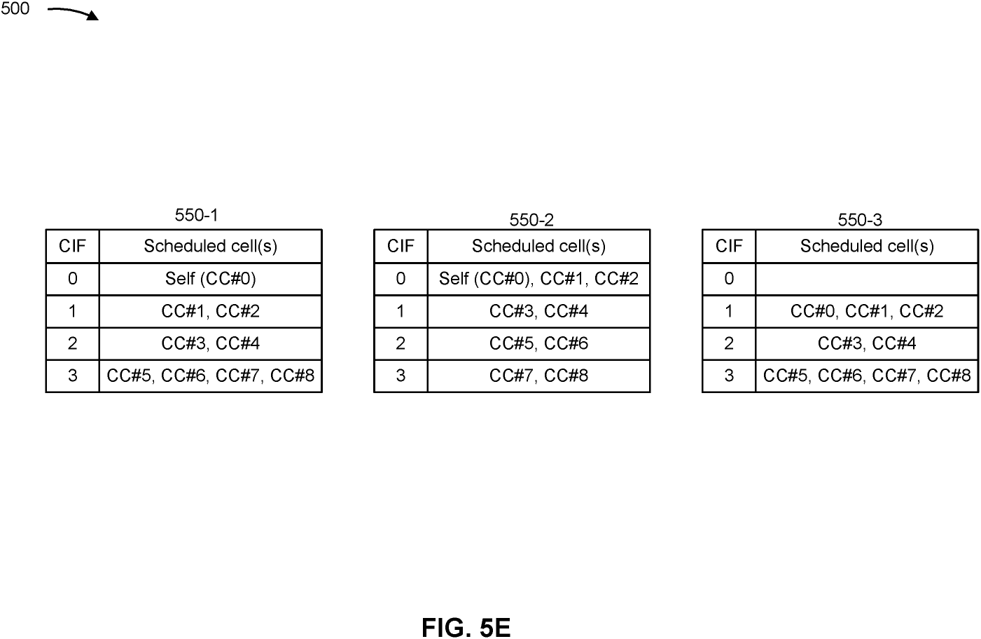

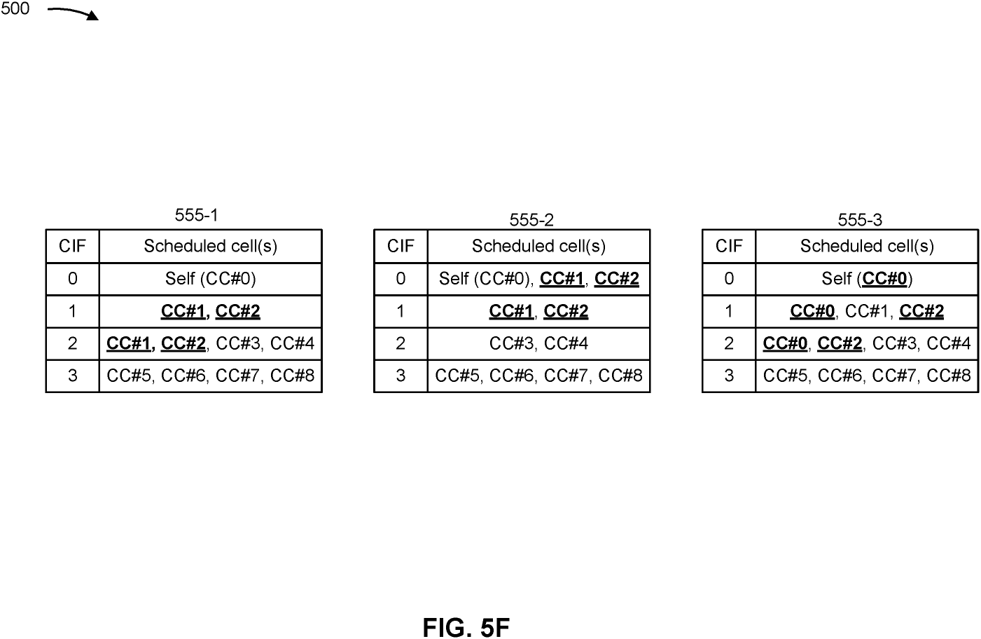

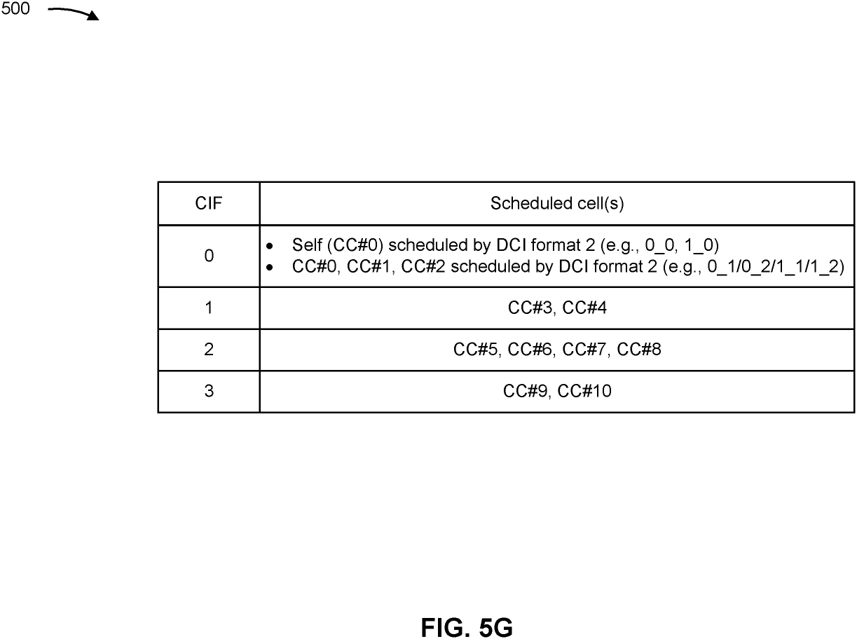

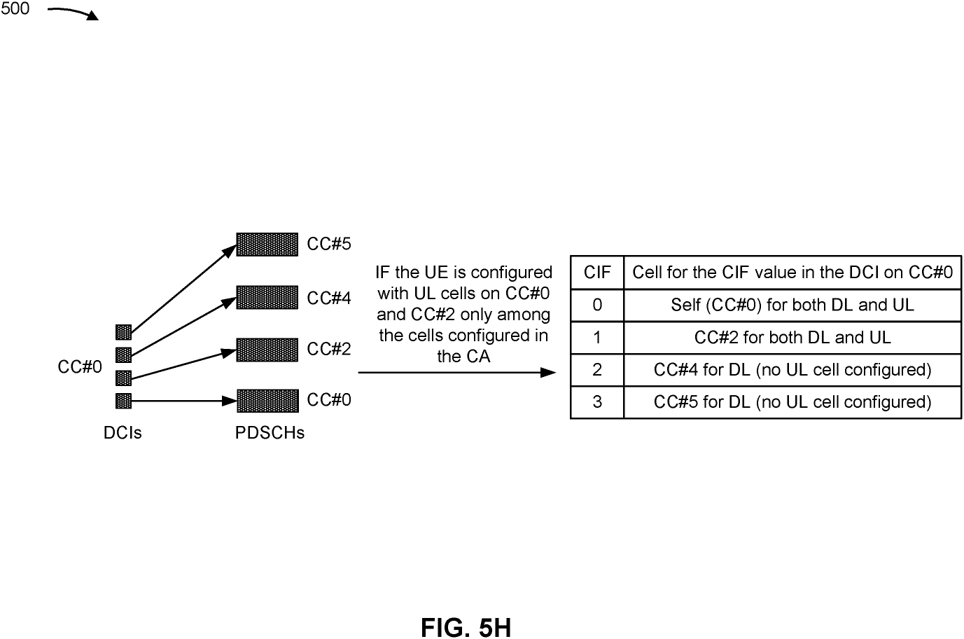

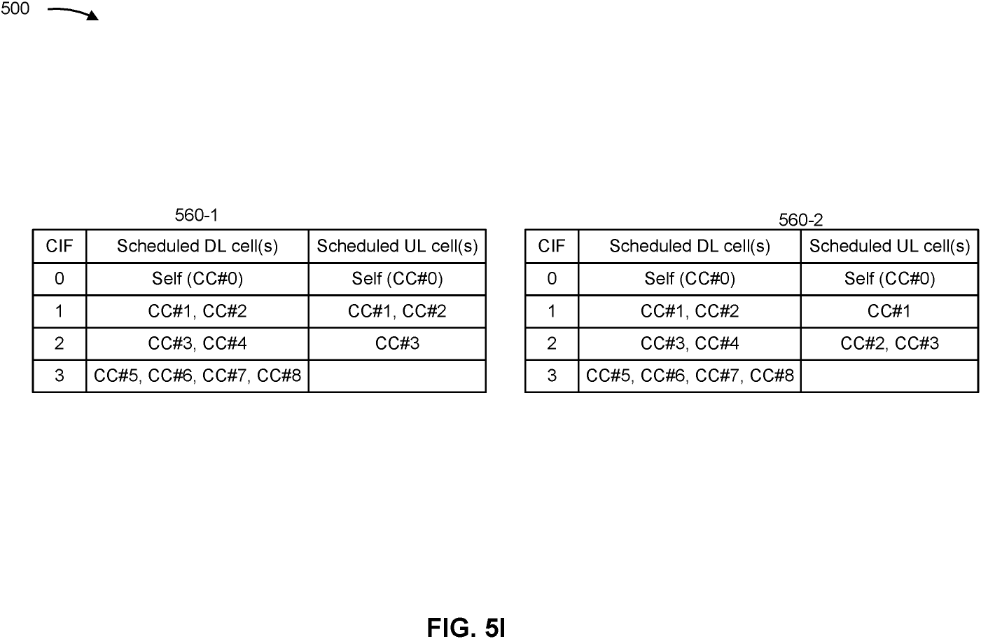

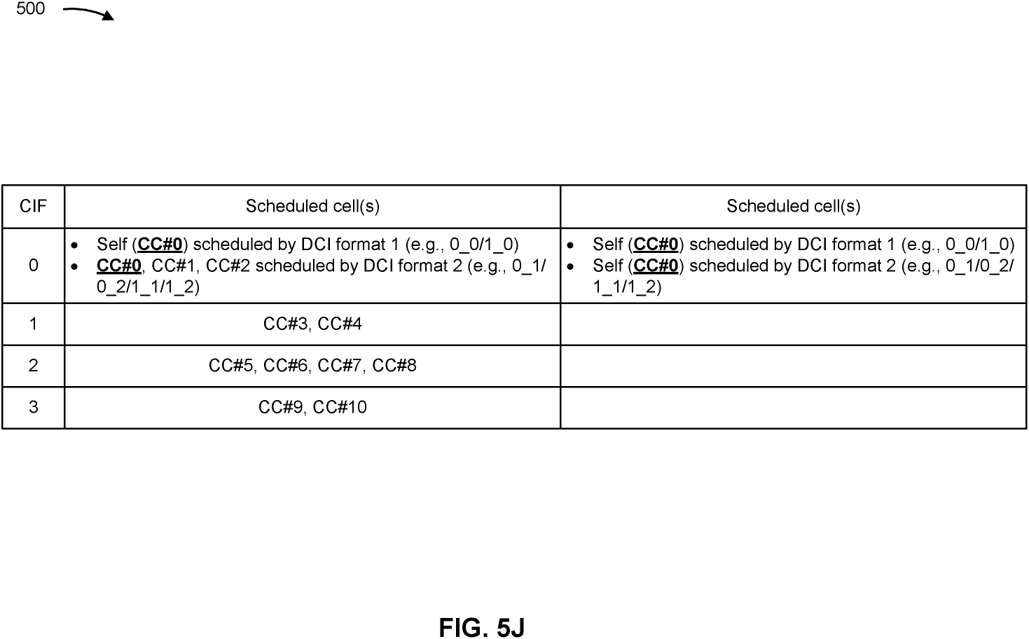

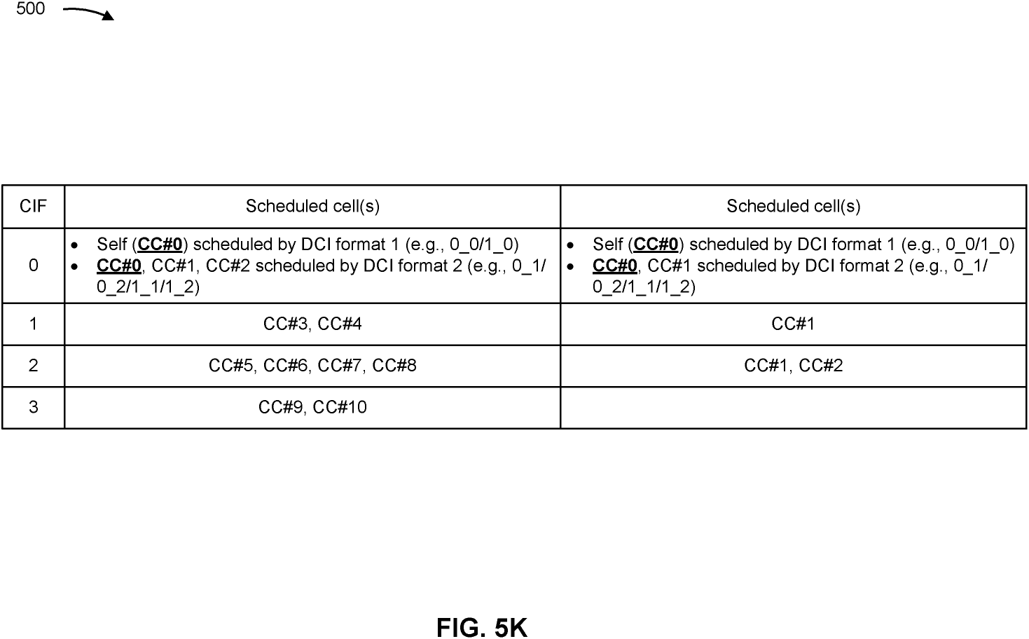

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIG. 5A-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIG. 5A-9).

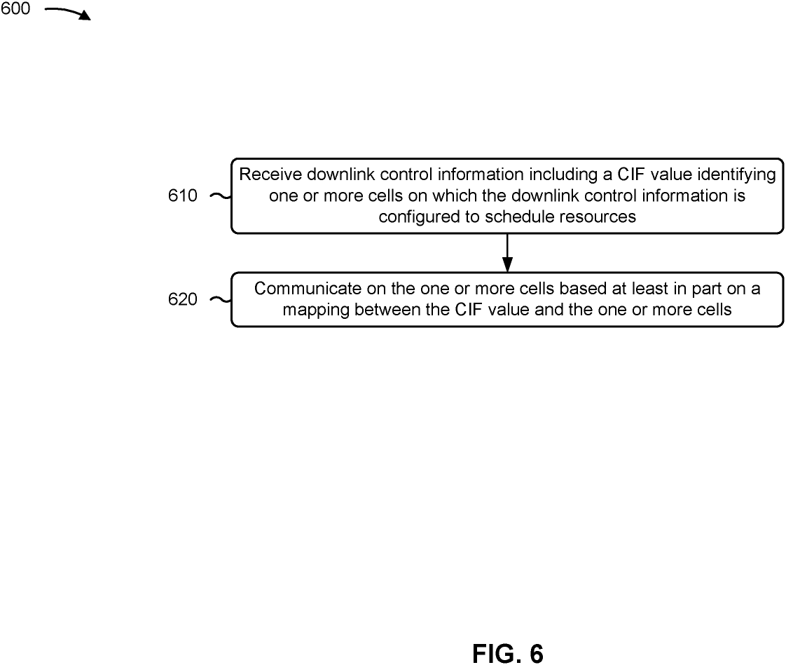

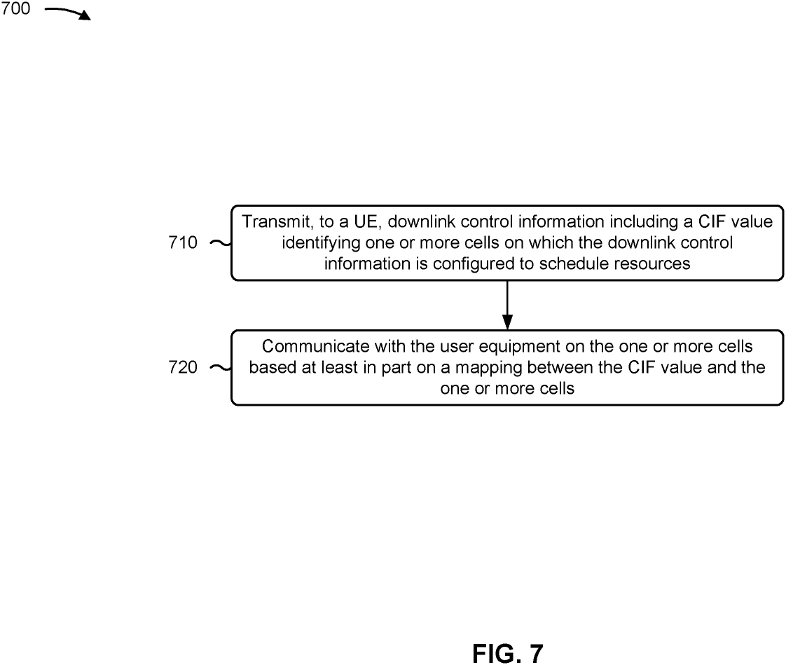

The controller/processor 240 of the network node 110, the controller/processor 280 of the UE 120, and/or any other component(s) of FIG. 2 may perform one or more techniques associated with CIF mapping, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving downlink control information including a CIF value identifying one or more cells on which the downlink control information is configured to schedule resources; and/or means for communicating on the one or more cells based at least in part on a mapping between the CIF value and the one or more cells. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, downlink control information including a CIF value identifying one or more cells on which the downlink control information is configured to schedule resources; and/or means for communicating with the UE on the one or more cells based at least in part on a mapping between the CIF value and the one or more cells. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

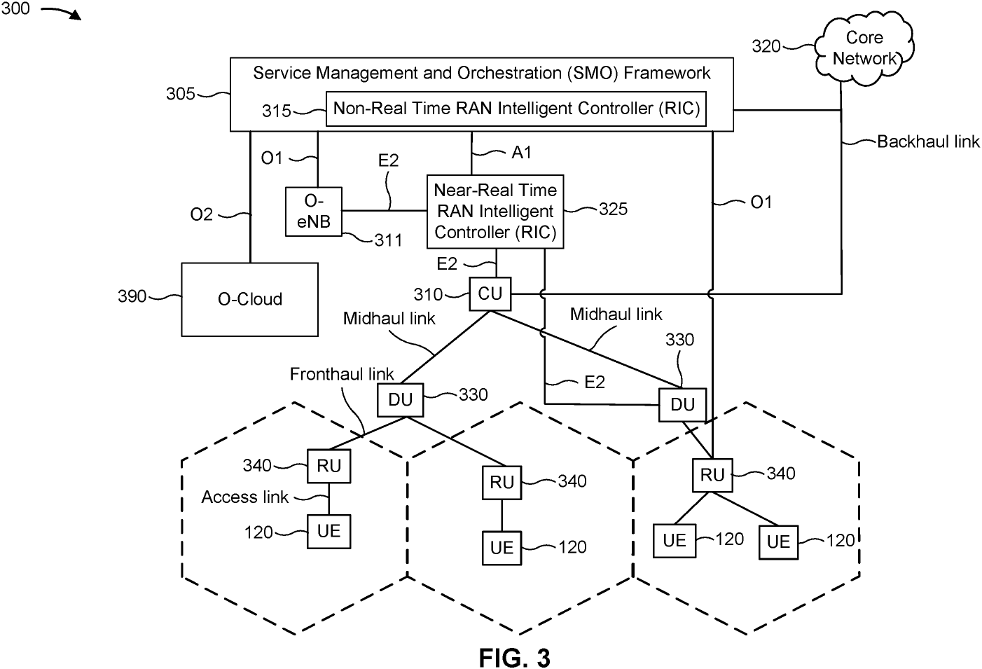

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit - User Plane (CU-UP) functionality), control plane functionality (for example, Central Unit - Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

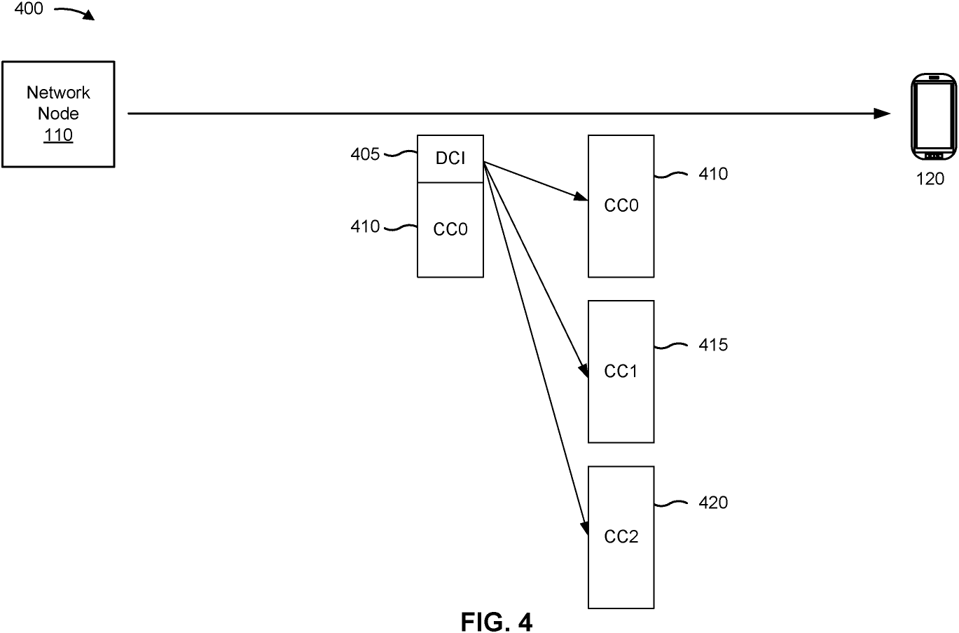

FIG. 4 is a diagram illustrating an example 400 of downlink control information (DCI) that schedules multiple cells, in accordance with the present disclosure. As shown in FIG. 4, a network node 110 and a UE 120 may communicate with one another.

The network node 110 may transmit, to the UE 120, DCI 405 that is configured to schedule one or more communications for the UE 120. The multiple communications may be scheduled for at least two different cells. In some cases, a cell may be referred to as a “component carrier,” a “CC,” or a “carrier.” In some cases, DCI that schedules a communication for a cell via which the DCI is transmitted may be referred to as self-carrier (or self-cell) scheduling DCI. In some cases, DCI that schedules a communication for a cell via which the DCI is transmitted may be referred to as cross-carrier (or cross-cell) scheduling DCI. In some aspects, the DCI 405 may be cross-carrier scheduling DCI, and may or may not be self-carrier scheduling DCI. In some aspects, the DCI 405 that carries communications in at least two cells may be referred to as combination DCI.

In example 400, the DCI 405 schedules a communication for a first cell 410 that carries the DCI 405 (shown as CC0), schedules a communication for a second cell 415 that does not carry the DCI 405 (shown as CC1), and schedules a communication for a third cell 420 that does not carry the DCI 405 (shown as CC2). In some aspects, the DCI 405 may schedule communications on a different number of cells than shown in FIG. 4 (e.g., two cells, four cells, five cells, and so on). The number of cells may be greater than or equal to two.

A communication scheduled by the DCI 405 may include a data communication, such as a physical downlink shared channel (PDSCH) communication or a physical uplink shared channel (PUSCH) communication. For a data communication, the DCI 405 may schedule a single transport block (TB) across multiple cells or may separately schedule multiple TBs in the multiple cells. Additionally, or alternatively, a communication scheduled by the DCI 405 may include a reference signal, such as a channel state information (CSI) reference signal (RS) (CSI-RS) or a sounding reference signal (SRS). For a reference signal, the DCI 405 may trigger a single resource for reference signal transmission across multiple cells or may separately schedule multiple resources for reference signal transmission in the multiple cells. In some cases, scheduling information in the DCI 405 may be indicated once and reused for multiple communications (e.g., on different cells), such as an MCS, a resource to be used for hybrid automatic repeat request (HARQ) acknowledgement (ACK) or negative acknowledgement (NACK) (ACK/NACK) of a communication scheduled by the DCI 405, and/or a resource allocation for a scheduled communication, to conserve signaling overhead.

As indicated above, FIG. 4 is provided as an example. Other examples may differ from what is described with respect to FIG. 4.

For cross-carrier scheduling (CCS) scenarios, a network node can set a cross-carrier scheduling configuration (crossCarrierSchedulingConfig) for each scheduled cell. The cross-carrier scheduling configuration may include one or more parameters, such as a parameter indicating which serving cell is a scheduling cell or a parameter indicating which CIF value corresponds to a scheduled cell, among other examples. The CIF value may indicate a mapping between a scheduling cell on which a DCI is transmitted and a scheduled cell on which a PDSCH can be scheduled by the DCI. For example, a CIF value of ‘0’ may indicate a first cell of a first carrier (e.g., self-scheduling), a CIF value of ‘1’ may indicate a second cell of a second carrier, or a CIF value of ‘2’ may indicate a third cell of a third carrier, among other examples.

A set of control channel elements (CCE) for a physical downlink control channel (PDCCH) candidate with a configured aggregation level may be based at least in part on a parameter n_{CI}, where the value of n_{CI} is indicated by or equivalent to the CIF value. Accordingly, DCI formats with different CIF values may correspond to different sets of CCEs for blind decoding. However, in multi-cell scheduling, the UE may lack information identifying the DCI format and an associated mapping of CIF values to cells or carriers. Some aspects described herein enable CIF mapping, such as in multi-cell scheduling scenarios. For example, some aspects described herein provide a CIF-based multi-cell scheduling mapping, which may enable a UE and/or a network node to determine a set of resources on which to communicate and/or to monitor for communication.

FIGS. 5A-5K are diagrams illustrating an example 500 associated with CIF mapping, in accordance with the present disclosure. As shown in FIG. 5A, example 500 includes communication between a UE 120 and a network node 110.

As further shown in FIG. 5A, and by reference number 510, the UE 120 may receive, from the network node 110, DCI. For example, the UE 120 may receive DCI with a CIF field set to a value from ‘0’ to ‘3’ to indicate one or more scheduled cells. Additionally, or alternatively, the CIF field may be set to a value in a range of ‘0’ to ‘7’ or another range for indicating a set of cells or carriers.

In some aspects, the UE 120 may map the CIF value to a carrier or cell to determine a resource in which to communicate with the network node 110. For example, the UE 120 may map the CIF value to a set of carriers using a configured mapping, such as a mapping table or codebook. In some aspects, a size (e.g., a payload) and a content (e.g., a set of fields) of a DCI format of the DCI is determined on a per CIF basis. For example, a DCI with a CIF value associated with multiple cells, as described herein, may include one or more dedicated or extended DCI fields for multi-cell scheduling. In some aspects, the network node 110 may align a size of a DCI format. For example, when a cell can be mapped from multiple CIF values, the network node 110 may align a size between two DCI formats with different CIF values associated with the same cell or carrier, as described herein. In other words, if two DCI formats are associated with different CIF values and can schedule the same cell, the network node 110 may add padding bits to a smaller DCI of the two DCIs to align respective sizes of the DCIs. Similarly, the network node 110 may align sizes between DCIs with different downlink cells and uplink cells identified therein, as described in more detail herein. Alternatively, the network node 110 may transmit DCIs with different sizes.

As shown in FIG. 5B, for multi-cell scheduling, a CIF value may map to one or more scheduled cells. For example, a first CIF value in the DCI (e.g., ‘0’) may map to a first carrier (e.g., carrier ‘CC#0’ for self-scheduling) and a second CIF value in the DCI (e.g., ‘1’) may map to a set of second carriers (e.g., carriers ‘CC#2’, ‘CC#4’, and CC#5’). In this case, the UE 120 may determine the CIF mapping (e.g., the one-to-one CIF mapping or the one-to-more-than-one CIF mapping) based at least in part on received radio resource configuration (RRC) signaling indicating the CIF mapping. As further shown in FIG. 5B, each carrier may be associated with a set of parameters, such as a scheduling cell information (schedulingCellInfo) parameter, a scheduling cell identifier (schedulingCellId) parameter, or a CIF in scheduling cell parameter (cifInSchedulingCell), among other examples. In this case, the value in the cifInSchedulingCell parameter is the same value for multiple cells that are configured with cross-carrier scheduling from the same scheduled cell. In other words, based at least in part on CC#2, CC#4, and CC#5 being schedulable from the same carrier, CC#0, in cross-carrier scheduling, each of CC#2, CC#4, and CC#5 have the same cifInSchedulingCell parameter.

As shown in FIGS. 5C and 5D, for multi-cell scheduling, a CIF value may map to both a self-scheduling carrier and a cross-carrier scheduling carrier. For example, the UE 120 may receive DCI on CC#0 that includes a CIF value indicating that the DCI is capable of scheduling PDSCHs on CC#0 and on CC#2 and CC#4. In some aspects, to indicate that CC#2 and CC#4 are scheduled from CC#0, which also self-schedules, a range of values for cifInSchedulingCell can be extended to 0, as shown in FIG. 5C. Additionally, or alternatively, rather than extend the range of values for cifInSchedulingCell to 0, the parameter schedulingCellInfo can be configured to a value other than ‘own’ (e.g., which indicates self-scheduling as shown in FIG. 5B), such as to a value of ‘1’, as shown in FIG. 5D. In this case, CC#0 is associated with a value of ‘1’ for cifInSchedulingCell, thereby grouping CC#0 with CC#2 and CC#4 for multi-cell scheduling.

In some aspects, the UE 120 may determine a search space for monitoring for DCI for multi-cell scheduling. For example, the UE 120 may determine a CCE for a PDCCH candidate based at least in part on CIF value. In this case, when there are one or more PDCCH candidates associated with the same CIF value, the same n_{CI} value corresponds to CCEs for the one or more PDCCH candidates. In some aspects, the UE 120 may monitor a quantity of search space sets for one or more serving cells corresponding to the n_{CI} value.

In some aspects, a scheduled cell can map to only a single CIF value. In this case, the UE 120 may monitor PDCCH candidates associated with CCEs corresponding to a single value of n_{CI}. In some cases, a maximum number of blind decodes or non-overlapped CCEs for one scheduled cell for the case where multi-cell scheduling is not configured maybe the PDCCH blind decode CCE budget and may be applicable to search space sets for PDCCHs and associated DCI with a CIF value for one or more cells. Alternatively, the maximum number of blind decodes or non-overlapped CCEs for one scheduled cell multiplied with an integer M may be the PDCCH blind decode CCE budget and may be applicable to search space sets for PDCCHs and associated DCI with a CIF value if the CIF value is associated with M cells. The network node 110 may configure the quantity of PDCCH candidates, such that a quantity of blind decodes or CCEs that the UE 120 is to process, for PDCCH and associated DCI reception with each CIF or n_{CI} value, does not exceed a PDCCH blind decode CCE budget per scheduled cell that the UE 120 can process in the scheduling cell. Alternatively, if the PDCCH blind decode CCE budget would be exceeded for a scheduled cell, the UE 120 may determine to not monitor one or more search space sets in a scheduling cell to avoid exceeding the blind decode CCE budget (e.g., this scenario may be termed a ‘PDCCH overbooking’ scenario). FIG. 5E shows a set of examples of CIF mappings for when a single scheduled cell can be mapped to only a single CIF value. For example, table 550-1 shows an example of CIF mapping to more than one scheduled cell (from one scheduling cell). Alternatively, tables 550-2 and 550-3 show examples of CIF mapping to more than one scheduled cell (from one scheduling cell) with self-scheduling (e.g., with an extended cifInSchedulingCell range or with a schedulingCellInfo configured to another value, respectively, as described above).

In some aspects, a scheduled cell can map to one or more CIF values. In this case, the UE 120 may monitor PDCCH candidates for each scheduled cell without a limitation to CCEs associated with a single value of n_{CI}. In some aspects, with mapping to one or more CIF values, a PDCCH blind decode CCE budget is applicable to search space sets for PDCCH and associated DCI with an n_{CI} and/or CIF value for one or more cells. Alternatively, the PDCCH blind decode CCE budget can be applicable to search space sets for DCIs with multiple CIF values when a cell can be scheduled by the DCIs. In this case, the network node 110 may configure a quantity of PDCCH candidates for one or more n_{CI} values associated with a cell, such that a quantity of blind decodes or CCEs that the UE 120 is to process, for the one or more n_{CI} values does not exceed the PDCCH blind decode CCE budget per scheduled cell that the UE 120 can process in a scheduling cell. Alternatively, as described above, the UE 120 may forgo monitoring one or more search space sets that exceed the blind decode CCE budget (e.g., in a PDCCH overbooking scenario). FIG. 5F shows a set of examples of CIF mappings for when a single scheduled cell can be mapped to one or more CIF value. For example, table 555-1 shows an example of CIF mapping to more than one scheduled cell (from one scheduling cell). Alternatively, tables 555-2 and 555-3 show examples of CIF mapping to more than one scheduled cell (from one scheduling cell) with self-scheduling (e.g., with an extended cifInSchedulingCell range or with a schedulingCellInfo configured to another value, respectively, as described above). As shown in each of the tables of FIG. 5F, a scheduled cell may map from multiple difference CIF values, such as CC#1 and CC#2 mapping from both CIF values of 1 and 2 in table 555-1.

In some aspects, the UE 120 may monitor for multiple types of DCI formats to receive the DCI with the CIF value. For example, for a scheduling cell, the UE 120 may monitor for a first DCI format for multi-cell scheduling and a second DCI format for single-cell scheduling. A DCI format for multi-cell scheduling may, in a first case, be a format where a DCI is capable of scheduling on multiple cells (but may not necessarily schedule on multiple cells). In this first case, when the DCI is capable of scheduling on multiple cells but only schedules on a single cell, the DCI is a multi-cell scheduling DCI. In a second case, the DCI format for multi-cell scheduling may be a format where the DCI does schedule on multiple cells. In other words, in this second case, when the DCI is capable of scheduling on multiple cells but only schedules on a single cell, the DCI is a single-cell scheduling DCI. In some aspects, on a scheduling cell (e.g., associated with a CIF value of 0), the UE 120 may monitor for the multi-cell scheduling DCI format and the single-cell scheduling DCI format. When the UE 120 receives a DCI with a format that does not include a CIF field, the UE 120 may determine PDCCH candidates for the DCI based at least in part on a hash function equation with a default CIF value (e.g., a default value for n_{CI} of 0). FIG. 5G shows an example of a CIF mapping for when the UE 120 is configured to monitor for multiple DCI formats. In this case, as shown, the mapping of the CIF value to scheduled cells is based at least in part on in which DCI format the CIF value is received.

In some aspects, a quantity of downlink cells or carriers and uplink cells or carriers is not the same. For example, the UE 120 may be configured to monitor a first quantity of downlink cells with a first downlink traffic pattern and a second quantity of uplink cells with a second uplink traffic pattern that may be independent of the first downlink traffic pattern. Accordingly, the UE 120 may have separate configurations for multi-cell scheduling for PDSCH reception on a downlink and PUSCH transmission on an uplink. For example, the UE 120 may have multi-cell PDSCH scheduling enabled on a downlink, but the UE 120 may not have multi-cell PUSCH scheduling enabled on an uplink or vice versa. Similarly, a DCI format may be configured for scheduling PDSCHs on a quantity N cells and for scheduling PUSCHs on a quantity M cells. In cross-carrier scheduling, the same DCI format can be used for PDSCH and PUSCH scheduling (e.g., a 1 bit format identifier is included in a DCI to distinguish between PDSCH and PUSCH scheduling), and a CIF value can point to the same scheduled cells for PDSCH and PUSCH scheduling.

FIG. 5H shows an example of CIF mapping where DCIs on CC#0 schedule onto CC#0, CC#2, CC#4, and CC#5 in accordance with a CIF mapping. As shown in the CIF mapping, PDSCH and PUSCH mapping may be the same for some CIF values (e.g., values 0 and 1), but for other values, only PDSCH mapping may be configured (e.g., CIF values 2 and 3) based at least in part on downlink being configured (but not uplink) on carriers corresponding to the other values, as shown. Alternatively, as shown in FIG. 5I, CIF values can map to downlink and uplink independently. In other words, as shown, the UE 120 may have a first mapping of CIF values to downlink cells and a second mapping of CIF values to uplink cells. In this case, in table 560-1, the uplink cells pointed by a CIF value can be restricted to a subset of the downlink cells pointed by the same CIF value or, in table 560-2, the uplink cells can be any set of uplink cells independent of the set of downlink cells pointed by the same CIF value. In some aspects, the respective CIF value mappings may be configured for the UE 120 by RRC signaling received from the network node 110 and indicated using a bit indicator (e.g., to indicate whether a received CIF value mapping is for uplink or downlink). FIGS. 5J and 5K show additional examples of independent uplink and downlink CIF mappings. For example, FIG. 5J shows an example of CIF mapping with downlink carrier aggregation with 11 carriers and no uplink carrier aggregation. In contrast, FIG. 5K shows an example of downlink carrier aggregation with 11 carriers and uplink carrier aggregation with 3 carriers.

Returning to FIG. 5A, and by reference number 520, the UE 120 may communicate with the network node 110 in accordance with the DCI. For example, the UE 120 may receive one or more PDSCHs on one or more carriers indicated by the DCI in connection with the CIF value and a mapping of CIF values to carriers or cells.

As indicated above, FIGS. 5A-5K are provided as an example. Other examples may differ from what is described with respect to FIGS. 5A-5K.

FIG. 6 is a diagram illustrating an example process 600 performed, for example, by a UE, in accordance with the present disclosure. Example process 600 is an example where the UE (e.g., UE 120) performs operations associated with carrier indicator field mapping.

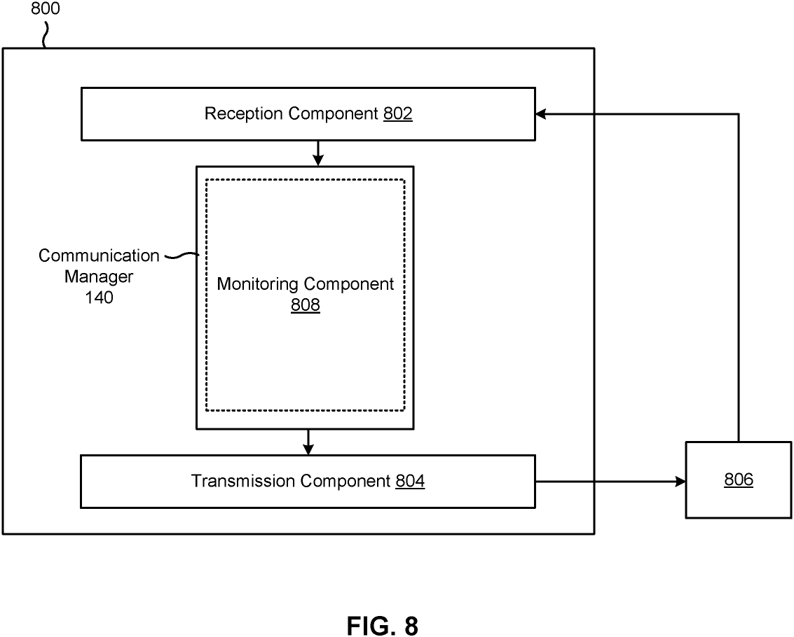

As shown in FIG. 6, in some aspects, process 600 may include receiving downlink control information including a CIF value identifying one or more cells on which the downlink control information is configured to schedule resources (block 610). For example, the UE (e.g., using communication manager 140 and/or reception component 802, depicted in FIG. 8) may receive downlink control information including a CIF value identifying one or more cells on which the downlink control information is configured to schedule resources, as described above in connection with FIGS. 5A-5K. In some aspects, the downlink control information may include a field assigned for conveying the CIF value. Additionally, or alternatively, the downlink control information may include a field not assigned for conveying the CIF value, but which a network node and a UE may use for communicating a CIF value. Additionally, or alternatively, the UE may infer a CIF value based at least in part on some other value in the downlink control information.

As further shown in FIG. 6, in some aspects, process 600 may include communicating on the one or more cells based at least in part on a mapping between the CIF value and the one or more cells (block 620). For example, the UE (e.g., using communication manager 140 and/or reception component 802 or transmission component 804, depicted in FIG. 8) may communicate on the one or more cells based at least in part on a mapping between the CIF value and the one or more cells, as described above in connection with FIGS. 5A-5K. In some aspects, the UE may identify cells on which to communicate based at least in part on the CIF value. For example, the UE may have a mapping between CIF values and cells on which the UE is to communicate. In this case, downlink control information, that included the CIF value, may schedule onto cells that correspond to the CIF value included in the downlink control information. The UE may store the mapping as a table or other data structure.

Process 600 may include additional aspects, such as any single aspect or any combination of aspects described below and/or in connection with one or more other processes described elsewhere herein.

In a first aspect, the CIF value is mapped to a plurality of cells that are configured with cross-carrier scheduling for at least one cell, of the plurality of cells, from a common scheduling cell.

In a second aspect, alone or in combination with the first aspect, the downlink control information schedules data on a same cell on which the downlink control information is conveyed.

In a third aspect, alone or in combination with one or more of the first and second aspects, a range of values for the CIF value is from 0 to at least 3.

In a fourth aspect, alone or in combination with one or more of the first through third aspects, a scheduling cell information parameter has a value of ‘other’ and a scheduling cell maps to a non-zero CIF value.

In a fifth aspect, alone or in combination with one or more of the first through fourth aspects, process 600 includes monitoring a search space set for the downlink control information, wherein a control channel element for a physical downlink control channel candidate associated with the downlink control information is based at least in part on the CIF value.

In a sixth aspect, alone or in combination with one or more of the first through fifth aspects, there is a one-or-more-to-one mapping of scheduled cells to CIF values.

In a seventh aspect, alone or in combination with one or more of the first through sixth aspects, there is a one-or-more-to-one-or-more mapping of scheduled cells to CIF values.

In an eighth aspect, alone or in combination with one or more of the first through seventh aspects, process 600 includes monitoring, for a scheduling cell associated with the CIF value, for a plurality of different downlink control information formats, wherein the plurality of different downlink control information formats includes at least one of a multi-cell scheduling format or a single-cell scheduling format.

In a ninth aspect, alone or in combination with one or more of the first through eighth aspects, the CIF value maps to a first set of scheduled downlink cells and a second set of scheduled uplink cells, wherein the first set of scheduled downlink cells is different from the second set of scheduled uplink cells.

In a tenth aspect, alone or in combination with one or more of the first through ninth aspects, the CIF value maps to a first set of scheduled downlink cells and a second set of scheduled uplink cells, wherein the second set of scheduled uplink cells is a subset of the first set of scheduled uplink cells.

In an eleventh aspect, alone or in combination with one or more of the first through tenth aspects, a size and a content of the downlink control information is associated with the CIF value.

In a twelfth aspect, alone or in combination with one or more of the first through eleventh aspects, the CIF value maps to a cell, and the downlink control information includes one or more padding bits to align a size with another downlink control information with another CIF value mapped to the cell.

In a thirteenth aspect, alone or in combination with one or more of the first through twelfth aspects, the CIF value maps to a first downlink cell and a second uplink cell that is different from or a subset of the first downlink cell, and the downlink control information schedules one of the first downlink cell or the second uplink cell and includes one or more padding bits to align a size with another downlink control information, which schedules the other of the first downlink cell or the second uplink cell.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., the network node 110) performs operations associated with CIF mapping.

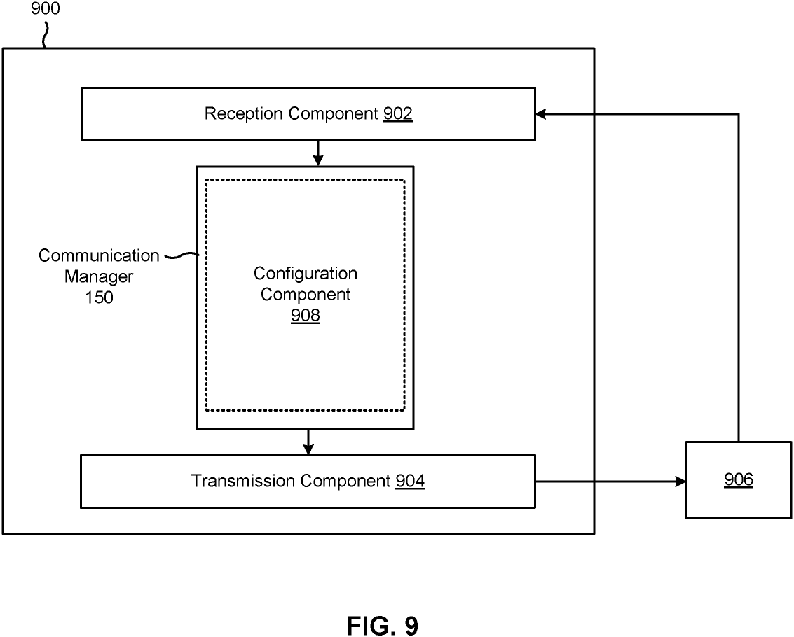

As shown in FIG. 7, in some aspects, process 700 may include transmitting, to a UE, downlink control information including a CIF value identifying one or more cells on which the downlink control information is configured to schedule resources (block 710). For example, the network node (e.g., using communication manager 150 and/or transmission component 904, depicted in FIG. 9) may transmit, to a UE, downlink control information including a CIF value identifying one or more cells on which the downlink control information is configured to schedule resources, as described above in connection with FIGS. 5A-5K. In some aspects, the downlink control information may include a field assigned for conveying the CIF value. Additionally, or alternatively, the downlink control information may include a field not assigned for conveying the CIF value, but which a network node and a UE may use for communicating a CIF value. Additionally, or alternatively, the network node may include some other value in the downlink control information based at least in part on which a UE can infer the CIF value.

As further shown in FIG. 7, in some aspects, process 700 may include communicating with the UE on the one or more cells based at least in part on a mapping between the CIF value and the one or more cells (block 720). For example, the network node (e.g., using communication manager 150 and/or reception component 902 or transmission component 904, depicted in FIG. 9) may communicate with the UE on the one or more cells based at least in part on a mapping between the CIF value and the one or more cells, as described above in connection with FIGS. 5A-5K. In some aspects, the UE may identify cells on which to communicate based at least in part on the CIF value. For example, the UE may have a mapping between CIF values and cells on which the UE is to communicate. In this case, downlink control information, that included the CIF value, may schedule onto cells that correspond to the CIF value included in the downlink control information. The UE may store the mapping as a table or other data structure. Based at least in part on the UE identifying cells on which to communicate, the UE can tune to the cells and transmit or receive and the network node may monitor the cells and/or transmit on the cells.

Process 700 may include additional aspects, such as any single aspect or any combination of aspects described below and/or in connection with one or more other processes described elsewhere herein.

In a first aspect, the CIF value is mapped to a plurality of cells that are configured with cross-carrier scheduling for at least one cell, of the plurality of cells, from a common scheduling cell.

In a second aspect, alone or in combination with the first aspect, the downlink control information schedules data on a same cell on which the downlink control information is conveyed.

In a third aspect, alone or in combination with one or more of the first and second aspects, a range of values for the CIF value is from 0 to at least 3.

In a fourth aspect, alone or in combination with one or more of the first through third aspects, a scheduling cell information parameter has a value of ‘other’ and a scheduling cell maps to a non-zero CIF value.

In a fifth aspect, alone or in combination with one or more of the first through fourth aspects, transmitting the downlink control information comprises transmitting the downlink control information in a search space set for the downlink control information, wherein a control channel element for a physical downlink control channel candidate associated with the downlink control information is based at least in part on the CIF value.

In a sixth aspect, alone or in combination with one or more of the first through fifth aspects, there is a one-or-more-to-one mapping of scheduled cells to CIF values.

In a seventh aspect, alone or in combination with one or more of the first through sixth aspects, there is a one-or-more-to-one-or-more mapping of scheduled cells to CIF values.

In an eighth aspect, alone or in combination with one or more of the first through seventh aspects, transmitting the downlink control information comprises transmitting, for a scheduling cell associated with the CIF value, the downlink control information with at least one of a plurality of different downlink control information formats, wherein the plurality of different downlink control information formats includes at least one of a multi-cell scheduling format or a single-cell scheduling format.

In a ninth aspect, alone or in combination with one or more of the first through eighth aspects, the CIF value maps to a first set of scheduled downlink cells and a second set of scheduled uplink cells, wherein the first set of scheduled downlink cells is different from the second set of scheduled uplink cells.

In a tenth aspect, alone or in combination with one or more of the first through ninth aspects, the CIF value maps to a first set of scheduled downlink cells and a second set of scheduled uplink cells, wherein the second set of scheduled uplink cells is a subset of the first set of scheduled uplink cells.

In an eleventh aspect, alone or in combination with one or more of the first through tenth aspects, a size and a content of the downlink control information is associated with the CIF value.

In a twelfth aspect, alone or in combination with one or more of the first through eleventh aspects, the CIF value maps to a cell, and the downlink control information includes one or more padding bits to align a size with another downlink control information with another CIF value mapped to the cell.

In a thirteenth aspect, alone or in combination with one or more of the first through twelfth aspects, the CIF value maps to a first downlink cell and a second uplink cell that is different from or a subset of the first downlink cell, and the downlink control information schedules one of the first downlink cell or the second uplink cell and includes one or more padding bits to align a size with another downlink control information, which schedules the other of the first downlink cell or the second uplink cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a network node, or another wireless communication device) using the reception component 802 and the transmission component 804. As further shown, the apparatus 800 may include the communication manager 140. The communication manager 140 may include a monitoring component 808, among other examples.

In some aspects, the apparatus 800 may be configured to perform one or more operations described herein in connection with FIGS. 5A-5K. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive downlink control information including a CIF value identifying one or more cells on which the downlink control information is configured to schedule resources. The reception component 802 and/or the transmission component 804 may communicate on the one or more cells based at least in part on a mapping between the CIF value and the one or more cells.

The monitoring component 808 may monitor a search space set for the downlink control information, wherein a control channel element for a physical downlink control channel candidate associated with the downlink control information is based at least in part on the CIF value. The monitoring component 808 may monitor, for a scheduling cell associated with the CIF value, for a plurality of different downlink control information formats, wherein the plurality of different downlink control information formats includes at least one of a multi-cell scheduling format or a single-cell scheduling format.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a network node, or another wireless communication device) using the reception component 902 and the transmission component 904. As further shown, the apparatus 900 may include the communication manager 150. The communication manager 150 may include a configuration component 908, among other examples.

In some aspects, the apparatus 900 may be configured to perform one or more operations described herein in connection with FIGS. 5A-5K. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The transmission component 904 may transmit, to a UE, downlink control information including a CIF value identifying one or more cells on which the downlink control information is configured to schedule resources. The reception component 902 or the transmission component 904 may communicate with the UE on the one or more cells based at least in part on a mapping between the CIF value and the one or more cells. The configuration component 908 may configure a CIF value for downlink control information transmitted to schedule resources.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving downlink control information including a carrier indicator field (CIF) value identifying one or more cells on which the downlink control information is configured to schedule resources; and communicating on the one or more cells based at least in part on a mapping between the CIF value and the one or more cells.

Aspect 2: The method of Aspect 1, wherein the CIF value is mapped to a plurality of cells that are configured with cross-carrier scheduling for at least one cell, of the plurality of cells, from a common scheduling cell.

Aspect 3: The method of any of Aspects 1 to 2, wherein the downlink control information schedules data on a same cell on which the downlink control information is conveyed.

Aspect 4: The method of any of Aspects 1 to 3, wherein a range of values for the CIF value is from 0 to at least 3.

Aspect 5: The method of any of Aspects 1 to 4, wherein a scheduling cell information parameter has a value of ‘other’ and a scheduling cell maps to a non-zero CIF value.

Aspect 6: The method of any of Aspects 1 to 5, further comprising: monitoring a search space set for the downlink control information, wherein a control channel element for a physical downlink control channel candidate associated with the downlink control information is based at least in part on the CIF value.

Aspect 7: The method of any of Aspects 1 to 6, wherein there is a one-or-more-to-one mapping of scheduled cells to CIF values.

Aspect 8: The method of any of Aspects 1 to 7, wherein there is a one-or-more-to-one-or-more mapping of scheduled cells to CIF values.

Aspect 9: The method of any of Aspects 1 to 8, further comprising: monitoring, for a scheduling cell associated with the CIF value, for a plurality of different downlink control information formats, wherein the plurality of different downlink control information formats includes at least one of a multi-cell scheduling format or a single-cell scheduling format.

Aspect 10: The method of any of Aspects 1 to 9, wherein the CIF value maps to a first set of scheduled downlink cells and a second set of scheduled uplink cells, wherein the first set of scheduled downlink cells is different from the second set of scheduled uplink cells.

Aspect 11: The method of any of Aspects 1 to 10, wherein the CIF value maps to a first set of scheduled downlink cells and a second set of scheduled uplink cells, wherein the second set of scheduled uplink cells is a subset of the first set of scheduled uplink cells.

Aspect 12: The method of any of Aspects 1 to 11, wherein a size and a content of the downlink control information is associated with the CIF value.

Aspect 13: The method of any of Aspects 1 to 12, wherein the CIF value maps to a cell, and wherein the downlink control information includes one or more padding bits to align a size with another downlink control information with another CIF value mapped to the cell.

Aspect 14: The method of any of Aspects 1 to 13, wherein the CIF value maps to a first downlink cell and a second uplink cell that is different from or a subset of the first downlink cell, and wherein the downlink control information schedules one of the first downlink cell or the second uplink cell and includes one or more padding bits to align a size with another downlink control information, which schedules the other of the first downlink cell or the second uplink cell.

Aspect 15: A method of wireless communication performed by a network node, comprising: transmitting, to a user equipment, downlink control information including a carrier indicator field (CIF) value identifying one or more cells on which the downlink control information is configured to schedule resources; and communicating with the user equipment on the one or more cells based at least in part on a mapping between the CIF value and the one or more cells.

Aspect 16: The method of Aspect 15, wherein the CIF value is mapped to a plurality of cells that are configured with cross-carrier scheduling for at least one cell, of the plurality of cells, from a common scheduling cell.

Aspect 17: The method of any of Aspects 15 to 16, wherein the downlink control information schedules data on a same cell on which the downlink control information is conveyed.

Aspect 18: The method of any of Aspects 15 to 17, wherein a range of values for the CIF value is from 0 to at least 3.

Aspect 19: The method of any of Aspects 15 to 18, wherein a scheduling cell information parameter has a value of ‘other’ and a scheduling cell maps to a non-zero CIF value.

Aspect 20: The method of any of Aspects 15 to 19, wherein transmitting the downlink control information comprises: transmitting the downlink control information in a search space set for the downlink control information, wherein a control channel element for a physical downlink control channel candidate associated with the downlink control information is based at least in part on the CIF value.

Aspect 21: The method of any of Aspects 15 to 20, wherein there is a one-or-more-to-one mapping of scheduled cells to CIF values.

Aspect 22: The method of any of Aspects 15 to 21, wherein there is a one-or-more-to-one-or-more mapping of scheduled cells to CIF values.

Aspect 23: The method of any of Aspects 15 to 22, wherein transmitting the downlink control information comprises: transmitting, for a scheduling cell associated with the CIF value, the downlink control information with at least one of a plurality of different downlink control information formats, wherein the plurality of different downlink control information formats includes at least one of a multi-cell scheduling format or a single-cell scheduling format.

Aspect 24: The method of any of Aspects 15 to 23, wherein the CIF value maps to a first set of scheduled downlink cells and a second set of scheduled uplink cells, wherein the first set of scheduled downlink cells is different from the second set of scheduled uplink cells.

Aspect 25: The method of any of Aspects 15 to 24, wherein the CIF value maps to a first set of scheduled downlink cells and a second set of scheduled uplink cells, wherein the second set of scheduled uplink cells is a subset of the first set of scheduled uplink cells.

Aspect 26: The method of any of Aspects 15 to 25, wherein a size and a content of the downlink control information is associated with the CIF value.

Aspect 27: The method of any of Aspects 15 to 26, wherein the CIF value maps to a cell, and wherein the downlink control information includes one or more padding bits to align a size with another downlink control information with another CIF value mapped to the cell.

Aspect 28: The method of any of Aspects 15 to 27, wherein the CIF value maps to a first downlink cell and a second uplink cell that is different from or a subset of the first downlink cell, and wherein the downlink control information schedules one of the first downlink cell or the second uplink cell and includes one or more padding bits to align a size with another downlink control information, which schedules the other of the first downlink cell or the second uplink cell.

Aspect 29: An apparatus for wireless communication at a device, comprising a processor; memory coupled with the processor; and instructions stored in the memory and executable by the processor to cause the apparatus to perform the method of one or more of Aspects 1-14.

Aspect 30: A device for wireless communication, comprising a memory and one or more processors coupled to the memory, the one or more processors configured to perform the method of one or more of Aspects 1-14.

Aspect 31: An apparatus for wireless communication, comprising at least one means for performing the method of one or more of Aspects 1-14.

Aspect 32: A non-transitory computer-readable medium storing code for wireless communication, the code comprising instructions executable by a processor to perform the method of one or more of Aspects 1-14.

Aspect 33: A non-transitory computer-readable medium storing a set of instructions for wireless communication, the set of instructions comprising one or more instructions that, when executed by one or more processors of a device, cause the device to perform the method of one or more of Aspects 1-14.

Aspect 34: An apparatus for wireless communication at a device, comprising a processor; memory coupled with the processor; and instructions stored in the memory and executable by the processor to cause the apparatus to perform the method of one or more of Aspects 15-28.

Aspect 35: A device for wireless communication, comprising a memory and one or more processors coupled to the memory, the one or more processors configured to perform the method of one or more of Aspects 15-28.

Aspect 36: An apparatus for wireless communication, comprising at least one means for performing the method of one or more of Aspects 15-28.

Aspect 37: A non-transitory computer-readable medium storing code for wireless communication, the code comprising instructions executable by a processor to perform the method of one or more of Aspects 15-28.

Aspect 38: A non-transitory computer-readable medium storing a set of instructions for wireless communication, the set of instructions comprising one or more instructions that, when executed by one or more processors of a device, cause the device to perform the method of one or more of Aspects 15-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive downlink control information including a carrier indicator field (CIF) value identifying one or more cells on which the downlink control information is configured to schedule resources; and
communicate on the one or more cells based at least in part on a mapping between the CIF value and the one or more cells.

2. The UE of claim 1, wherein the CIF value is mapped to a plurality of cells that are configured with cross-carrier scheduling for at least one cell, of the plurality of cells, from a common scheduling cell.

3. The UE of claim 1, wherein the downlink control information schedules data on a same cell on which the downlink control information is conveyed.

4. The UE of claim 1, wherein a range of values for the CIF value is from 0 to at least 3.

5. The UE of claim 1, wherein a scheduling cell information parameter has a value of ‘other’ and a scheduling cell maps to a non-zero CIF value.

6. The UE of claim 1, wherein the one or more processors are further configured to:
monitor a search space set for the downlink control information, wherein a control channel element for a physical downlink control channel candidate associated with the downlink control information is based at least in part on the CIF value.

7. The UE of claim 1, wherein there is a one-or-more-to-one mapping of scheduled cells to CIF values.

8. The UE of claim 1, wherein there is a one-or-more-to-one-or-more mapping of scheduled cells to CIF values.

9. The UE of claim 1, wherein the one or more processors are further configured to:
monitor, for a scheduling cell associated with the CIF value, for a plurality of different downlink control information formats, wherein the plurality of different downlink control information formats includes at least one of a multi-cell scheduling format or a single-cell scheduling format.

10. The UE of claim 1, wherein the CIF value maps to a first set of scheduled downlink cells and a second set of scheduled uplink cells, wherein the first set of scheduled downlink cells is different from the second set of scheduled uplink cells.

11. The UE of claim 1, wherein the CIF value maps to a first set of scheduled downlink cells and a second set of scheduled uplink cells, wherein the second set of scheduled uplink cells is a subset of the first set of scheduled uplink cells.

12. The UE of claim 1, wherein a size and a content of the downlink control information is associated with the CIF value.

13. The UE of claim 1, wherein the CIF value maps to a cell, and
wherein the downlink control information includes one or more padding bits to align a size with another downlink control information with another CIF value mapped to the cell.

14. The UE of claim 1, wherein the CIF value maps to a first downlink cell and a second uplink cell that is different from or a subset of the first downlink cell, and
wherein the downlink control information schedules one of the first downlink cell or the second uplink cell and includes one or more padding bits to align a size with another downlink control information, which schedules the other of the first downlink cell or the second uplink cell.

15. A network node for wireless communication, comprising:
a memory; and
one or more processors, coupled to the memory, configured to:
transmit, to a user equipment, downlink control information including a carrier indicator field (CIF) value identifying one or more cells on which the downlink control information is configured to schedule resources; and
communicate with the user equipment on the one or more cells based at least in part on a mapping between the CIF value and the one or more cells.

16. The network node of claim 15, wherein the CIF value is mapped to a plurality of cells that are configured with cross-carrier scheduling for at least one cell, of the plurality of cells, from a common scheduling cell.

17. The network node of claim 15, wherein the downlink control information schedules data on a same cell on which the downlink control information is conveyed.

18. The network node of claim 15, wherein a range of values for the CIF value is from 0 to at least 3.

19. The network node of claim 15, wherein a scheduling cell information parameter has a value of ‘other’ and a scheduling cell maps to a non-zero CIF value.

20. The network node of claim 15, wherein the one or more processors, to transmit the downlink control information, are configured to:
transmit the downlink control information in a search space set for the downlink control information, wherein a control channel element for a physical downlink control channel candidate associated with the downlink control information is based at least in part on the CIF value.

21. The network node of claim 15, wherein there is a one-or-more-to-one mapping of scheduled cells to CIF values.

22. The network node of claim 15, wherein there is a one-or-more-to-one-or-more mapping of scheduled cells to CIF values.

23. The network node of claim 15, wherein the one or more processors, to transmit the downlink control information, are configured to:
transmit, for a scheduling cell associated with the CIF value, the downlink control information with at least one of a plurality of different downlink control information formats, wherein the plurality of different downlink control information formats includes at least one of a multi-cell scheduling format or a single-cell scheduling format.

24. The network node of claim 15, wherein the CIF value maps to a first set of scheduled downlink cells and a second set of scheduled uplink cells, wherein the first set of scheduled downlink cells is different from the second set of scheduled uplink cells.

25. The network node of claim 15, wherein the CIF value maps to a first set of scheduled downlink cells and a second set of scheduled uplink cells, wherein the second set of scheduled uplink cells is a subset of the first set of scheduled uplink cells.

26. The network node of claim 15, wherein a size and a content of the downlink control information is associated with the CIF value.

27. The network node of claim 15, wherein the CIF value maps to a cell, and
wherein the downlink control information includes one or more padding bits to align a size with another downlink control information with another CIF value mapped to the cell.

28. The network node of claim 15, wherein the CIF value maps to a first downlink cell and a second uplink cell that is different from or a subset of the first downlink cell, and
wherein the downlink control information schedules one of the first downlink cell or the second uplink cell and includes one or more padding bits to align a size with another downlink control information, which schedules the other of the first downlink cell or the second uplink cell.

29. A method of wireless communication performed by a user equipment (UE), comprising:
receiving downlink control information including a carrier indicator field (CIF) value identifying one or more cells on which the downlink control information is configured to schedule resources; and
communicating on the one or more cells based at least in part on a mapping between the CIF value and the one or more cells.

30. A method of wireless communication performed by a network node, comprising:
transmitting, to a user equipment, downlink control information including a carrier indicator field (CIF) value identifying one or more cells on which the downlink control information is configured to schedule resources; and
communicating with the user equipment on the one or more cells based at least in part on a mapping between the CIF value and the one or more cells.
